(19) United States
(12) Patent Application Publication
(10) Pub. No.: US 2008/0173196 A1
(43) Pub. Date: Jul. 24, 2008

(54) SLEEVE FOR PRINTING CYLINDER, PRINTING MACHINE AND METHOD OF REPLACING INNER PERIPHERAL LAYER OF SLEEVE FOR PRINTING CYLINDER

(75) Inventors: Torao IWAMOTO, Hiroshima-ken (JP); Hiroshi KOBARA, Hiroshima-ken (JP); Tatsuro YOSHIDA, Osaka (JP); Makoto TANAKA, Osaka (JP)

Correspondence Address: KANESAKA BERNER AND PARTNERS LLP, 1700 DIAGONAL RD, SUITE 310, ALEXANDRIA, VA, 22314-2848, US

(73) Assignees: MITSUBISHI HEAVY INDUSTRIES, LTD., Tokyo (JP); KATSURA ROLLER MFG. CO., LTD., Osaka (JP)

(21) Appl. No.: 11/964,605

(22) Filed: Dec. 26, 2007

(30) Foreign Application Priority Data
Dec. 27, 2006 (JP) 2006-352834

(51) Int. Cl. B41F 13/10

(52) U.S. Cl. 101/375; 29/428

(57) ABSTRACT

Provided is a offset web press, particularly a variable cutoff type web press, which can reduce costs of replacement of a sleeve for a printing cylinder, which is deteriorated through printing operation. The sleeve for a printing cylinder, which is cylindrical and which is fitted on the outer periphery of a base shaft roll provided on the body side of the printing machine, is composed of an inner peripheral layer having a plurality of layers at least one of which is expandable or contractible with respect to a radial load, and an outer peripheral cylinder closely fitted on the outer peripheral surface of the inner peripheral layer, the inner peripheral layer and the outer peripheral layer being formed separate from each other so as to be separatable from each other. With this configuration, in order to replace the sleeve with the inner peripheral layer being deteriorated, the inner peripheral layer can be removed from the outer peripheral layer and be replaced with new one while the outer peripheral layer can be used as it is, thereby it is possible to greatly reduce the replacement costs of the sleeve, in comparison with a conventional sleeve which has been replaced with new one in its entirety.

### RELATED APPLICATIONS

The present application is based on, and claims priority from, Japanese Application Number 2006-352834, filed Dec. 27, 2006, the disclosure of which is hereby incorporated by reference herein in its entirety.

### BACKGROUND OF THE INVENTION

1. Field of the Invention

The present invention relates to a sleeve for a printing cylinder, adapted to be used as a sleeve for a plate cylinder or a sleeve for a blanket cylinder, and in particular, to a sleeve for a printing cylinder, which is preferably used in a web press of a variable cut-off type capable of changing a cut-off length of a web, and which aims at reducing the costs for replacement thereof. The present invention also relates to a method of fitting and removing an inner peripheral layer of a sleeve for a printing cylinder.

2. Description of the Related Art

In a web press, plate cylinders and blanket cylinders are arranged respectively at the upper and lower surfaces of a web (continuous paper) in order to print both surfaces of the latter. Further, the plate cylinders are wrapped therearound with press plates over their outer surfaces while the blanket cylinders are wrapped therearound with elastic blankets over their outer surfaces, and accordingly, contents to be printed are transferred from the press plates onto the blankets from which the contents to be printed are transferred onto the web passing through a gap between the upper and lower blankets.

Recently, as to the above-mentioned web press, various kinds of web-presses capable of changing the cut-off length of a web have been proposed. For example, a patent document 1 (Japanese patent Laid-Open No. 2004-181931) discloses a variable cutoff type web press as one kind thereof, in which the diameter of a printing cylinder (a plate cylinder or a blanket cylinder) is changed by changing the diameter (thickness) of a cylindrical sleeve adapted to be fitted on the outer periphery of a base shaft roll provided on the printing machine body side, and in which the position of the center axis of a part of the printing cylinders is changed.

The above-mentioned sleeve for a printing cylinder is composed of a plurality of resin layers, as disclosed in a patent document 2 (Japanese Patent Laid-Open No. H02-243344), and when the sleeve for a printing cylinder is fitted on the base shaft roll, the inner diameter of the sleeve is enlarged by compressed air jetted from the outer periphery of the base shaft roll, and then the sleeve is fitted onto the base shaft roll, as disclosed in a patent document 3 (Japanese Patent Laid-Open No. H10-95102).

That is, the sleeve for a printing cylinder is formed such that the inner diameter thereof is slightly smaller than the outer diameter of the base shaft roll, and accordingly, the sleeve is fitted onto and is pulled out from the base shaft roll in the axial direction of the latter after the inner diameter of the sleeve is enlarged by the compressed air jetted from the outer periphery of the base shaft roll. Thus, the sleeve can be mounted on or removed from the base shaft roll. The mounting of the sleeve is completed by stopping the supply of the compressed air after the fitting of the sleeve so as to allow the sleeve to reduce its diameter in order to make into close contact with the outer periphery of the base shaft roll.

It is noted in this specification that the sleeve for a printing cylinder will be hereinbelow referred to “sleeve for a printing cylinder” or simply to “sleeve” whenever explanation is made without the necessity of distinction between a sleeve for a plate cylinder and a sleeve for a blanket cylinder.

However, it may not be safely said that the resin sleeve has a sufficient strength or durability, and accordingly, it is difficult to attach a holder for gripping opposite ends of a press plate or a blanket and fixing it, to the sleeve. This problem becomes in particular severe if the press roll is of a variable cut-off type which is large-sized, which is operated at a high speed, and in which frequent replacement of press plates is required.

Thus, in order to solve the above-mentioned problems, the inventors have proposed a cylindrical sleeve for a printing cylinder, composed of a deformable layer as an inner peripheral layer, which is radially expandable, such as a resin layer, and an outermost peripheral layer made of metal. The sleeve for a printing roll has aimed at enhancing its strength and the durability since it has the outermost peripheral layer made of metal in order to solve the above-mentioned problems.

However, in the above-mentioned sleeve for a printing cylinder, the deformable layer formed of a resin layer or the like gradually deteriorates its performance as it is used for printing operation for a long time. The deformable layer in the sleeve for a printing cylinder, which is made into close contact with and fixed to the outer periphery of the base shaft roll gradually deteriorate its elasticity in long time printing operation since the printing roll is rotated at a high speed of 800 to 1,000 rpm so as to be repeatedly subjected to compression in its nip part and extension in the part other than nip part during printing operation.

Thus, the adherence between the sleeve and the base shaft roll becomes weaker. Further, the degree of expansion and contraction of the sleeve becomes larger under the same operating condition as that before it has been deteriorated. Should the adherence become lower and the degree of expansion and contraction become larger, eccentricity between the sleeve and the base shaft roll would be caused, resulting in unstable rotation. In this condition, the pressing force between the plate cylinder and the blanket cylinder is lowered and become instable. In this condition, the degree of accuracy for registration of a pattern becomes lower, and as a result, there would be caused such a printing hindrance that the clearness of the pattern is lowered.

When the performance of the deformable layer has deteriorated, it is required to replace the sleeve with a new one in its entirely. However, the sleeve is expensive per unit, and accordingly, there would be caused such a problem that the replacement costs thereof would be excessive since the outermost layer of the sleeve is made of metal such as aluminum in order to attach a holder for mounting a press plate or a blanket thereto

For example, in a web press for double surface printing has four units for printing cyan, yellow, magenta and black so as to carry out color printing with the use of color mixture thereof. Since each unit requires four sleeves for four plates and blanket cylinders in total, 16 sleeves are in total required for the four printing units. Further, in the case of a variable cutoff type, since two sets of sleeves having diameters different from each other are prepared for each unit, 32 sleeves in total are required, and accordingly, estimating that the unit price of the sleeve is about ¥500,000, the costs of ¥500,000×32=¥16,000,000 would be required for one time replacement of sleeves.

### SUMMARY OF THE INVENTION

The present invention is devised in view of the above-mentioned problems inherent to the prior art, and an object of the present invention is to provide a sleeve for a printing cylinder in an offset web press, in particular, in a variable cutoff type web press, which can restrain the costs of replacement of a sleeve deteriorated during printing operation, without incurring complication during replacement thereof, and to provide a method of replacing an inner peripheral layer of the sleeve.

To the end, according to the present invention, there is provided a sleeve for a printing cylinder, which is cylindrical and which is adapted to be fitted on an outer periphery of a base shaft roll provided on the printing machine body side, the sleeve including an inner peripheral layer composed of layers which are at least in part elastic with respect to a radial load, and an outer peripheral layer closely fitted on an outer peripheral surface of the inner peripheral layer, the inner peripheral layer and the outer peripheral layer being formed, separate from each other, that is, they are separatable from each other.

According to the present invention, since the outer peripheral layer and the inner peripheral layer are formed, separate from each other, that is, they are separatable from each other, when the inner peripheral layer is deteriorated during printing operation or its service life is expired, only the inner peripheral layer can be removed and replaced with a new one. Since only the inner layer can be replaced, when the inner layer is deteriorated, it is not necessary to replace the entire sleeve with new one, thereby it is possible to greatly reduce the costs of replacement in comparison with the prior art. It is noted that the outer peripheral layer is preferably made of a metal material in order to keep the strength and durability of the sleeve while the inner peripheral layer is preferably made of nonmetallic materials in order to cause the inner peripheral layer to include an elastic layer, and as well to decrease the weight of the sleeve.

For example, if the inner peripheral layer is made of resin, the price of one inner layer is about ¥50,000, and accordingly, in the case of a variable cutoff type web press, the costs of one time replacement of sleeves would be ¥50,000×16 (pieces)×2 (set)=¥160,000, thereby it is possible to reduce the costs to one-tenth of that of the conventional web press.

In a specific form of the present invention, the sleeve for a printing cylinder is formed in an axial end part thereof with a supply passage for feeding compressed gas for removing the inner peripheral layer and is also formed with jet ports connected with the supply passage, for jetting the compressed gas from the inner peripheral surface of the outer peripheral layer toward the inner peripheral layer in the end part thereof, thereby it is possible to simply carrying out the removal and fitting of the inner peripheral layer from and into the outer peripheral layer.

With the above-mentioned configuration, in the case of removing or fitting the inner peripheral layer from and into the outer peripheral layer, air, inert gas or the like is jetted from the gas jet ports so as to decrease the outer diameter of the inner peripheral layer in order to form a gas layer (an air layer) at the boundary between the outer peripheral layer and the inner peripheral layer, thereby it is possible to reduce the contact area between the outer peripheral surface of the inner peripheral layer and the inner peripheral surface of the outer peripheral layer can be reduced. Thus, the frictional force between the outer peripheral surface of the inner peripheral layer and the inner peripheral surface of the outer peripheral layer can be reduced when the inner peripheral layer is fitted into and removed from the inner peripheral surface of the outer peripheral layer, thereby it is possible to simply remove and fit the inner peripheral layer from and into the outer peripheral layer.

Further, with the provision of circumferential groove in the outer peripheral surface of the inner peripheral layer, the contact area between the inner and outer peripheral layers (that is, the contact area between the outer peripheral surface of the inner peripheral layer and the inner peripheral surface of the outer peripheral layer) becomes less during the removal and fitting of the inner peripheral layer. That is, the frictional force exerted to the contact surfaces of the inner and outer peripheral layers can be reduced when the inner peripheral layer is removed from the outer peripheral layer.

Further, since the compressed gas is smoothly led between the inner peripheral surface of the outer peripheral layer and the outer peripheral surface of the inner peripheral layer through the intermediary of the groove, the gas layer (air layer) is efficiently formed between the contact surfaces of the inner and outer peripheral layers, thereby it is possible to carry out smooth removal and fitting of the inner peripheral layer.

In the sleeve for a printing cylinder according to the present invention, a part of the outer peripheral layer which can reduce its strength, may be formed therein with a hollow space, and a light weight nonmetallic material may be filled in the hollow space, thereby it is possible to make the sleeve lightweight while maintaining its required strength. If a foamed urethane is used as the nonmetallic material, it is possible to aim at greatly making the sleeve lightweight without substantially reducing the strength thereof in comparison with the metal material.

Further, in a specific configuration, the outer peripheral layer of the sleeve for a printing cylinder may be composed of a first cylinder having an inner peripheral surface with a diameter substantially equal to the diameter of the outer peripheral surface of the inner peripheral layer, and a second cylinder which is made of a metal material and which is arranged on the outside of the first cylinder, being aligned with the first cylinder at their centers so as to be concentric with each other, and further, a lightweight nonmetallic material may be filled between the first cylinder and the second cylinder. As the nonmetallic material filled therebetween, thee may be used a foamed urethane layer formed by filling liquid urethane, and foaming and solidifying the same.

With the use of a metal having a high degree of working accuracy, a high strength and a long service life, such as Ni, for the first cylinder, the first cylinder having a thin wall may be easily produced with a high degree of accuracy, then, a cylinder made of a metal material such as aluminum alloy and constituting the outermost layer of the outer peripheral layer is arranged outside of the first cylinder, being aligned therewith at its their centers so as to be concentric with each other, and a lightweight nonmetallic material is filled between the two cylinders, thereby it is possible to simply manufacture a lightweight outer peripheral layer without substantially lowering its strength. As the lightweight nonmetallic material, a foamed urethane which is obtained by filling a liquid urethane and then by foaming and solidifying the urethane is preferably used. Since the specific weight of the foamed urethane about 0.2 times as large as that of aluminum alloy while having a high strength, a lightweight sleeve having a high strength can be manufactured.

Further, according to the present invention, there is provided a printing machine comprising a sleeve for a printing cylinder having the above-mentioned configuration, and since the sleeve is composed of an outer peripheral layer and an inner peripheral layer which are separate from each other, that is, which are seperatable from each other, only the inner peripheral layer can be replaced with new one when the inner peripheral layer is deteriorated, thereby it is possible to greatly reduce costs required for replacement of the sleeve in comparison with the conventional one.

Further, according to the present invention, there is provided a method of fitting and removing an inner peripheral layer into and from a sleeve, in which a compressed gas fed into the compressed gas supply passage is jetted from the jet ports so as to form a gas layer at the boundary between the inner peripheral layer and the outer peripheral layer in order to decrease the diameter of the inner peripheral layer while decreasing the contact area between the inner and outer peripheral layers, and in this condition, the inner peripheral layer is fitted into the inner peripheral layer of the outer peripheral layer or pulled out from the inner peripheral layer the outer peripheral layer.

At this stage, if the inner peripheral layer is fitted in the outer peripheral layer, the inner peripheral layer is fitted in the inner peripheral surface of the outer peripheral layer, and thereafter, the supply of the compressed gas is stopped so as to allow the inner peripheral layer to restore its original diameter, thereby it is possible to fix the inner layer to the inner peripheral layer of the outer peripheral layer in a close contact with each other.

In the removal and fitting method according to the present invention, the inner peripheral layer is preferably formed in its outer peripheral surface with circumferential groove in which compressed gas is introduced, in order to readily form a gas layer between the inner peripheral surface of the outer peripheral layer and the outer peripheral surface of the inner peripheral layer. With the thus formed gas layer, the contact area between the inner and outer peripheral layers can be reduced, thereby it is possible to smoothly carry out removal and fitting of the inner peripheral layer. It is noted that for example, air or nitrogen can be used for the compressed gas.

According to the present invention, the sleeve for a printing cylinder includes an inner peripheral layer composed of a plurality of layers at least a part of which is elastic with respect to a radial load, and an outer peripheral layer made into close contact with the outer peripheral surface of the inner peripheral layer, the inner peripheral layer and the outer peripheral layer being formed, separate from each other, that is, they are separatable from each other. Thus, in the case of replacement of the sleeve with the inner peripheral layer therein being deteriorated, the inner peripheral layer can be removed alone from the outer peripheral layer so as to be replaced with new one, that is, the outer peripheral layer can be used as it is, thereby it is possible to greatly reduce the costs of the replacement in comparison with a conventional sleeve which is replaced with new one in its entirety.

Further, according to the present invention, there is provided a printing machine incorporated with a sleeve for a printing cylinder, which is cylindrical and which is adapted to be fitted on the outer periphery of a base shaft roll provided on the printing machine body side,

the sleeve for a printing cylinder is composed of an inner peripheral layer having a plurality of layers at least a part of which is elastic with respect to a radial load, and an outer peripheral layer closely fitted on the outer peripheral surface of the inner peripheral layer, characterized in that the inner peripheral layer and the outer peripheral layer are formed, separate from each other, that is, they are separatable from each other, further, the sleeve is used as a sleeve for a plate cylinder or a sleeve for a blanket cylinder, and the printing machine is used as a variable cutoff type web press capable of changing a cutoff length of a web.

In the printing machine according to the present invention, the sleeve is in particular effective for a printing cylinder which is conventionally difficult to mount a holder for gripping both ends of a plate or a blanket so as to fix it to the sleeve, and further, it is in particular effective for a large-sized and high speed web press of a variable cutoff type which require frequent replacement of press plates.

The printing machine according to the present invention, can greatly reduce the costs of replacement of sleeves due to the provision of the sleeve having the above-mentioned configuration.

Further, according to the present invention, a method of fitting and removing an inner peripheral layer of a sleeve for a printing cylinder, which includes an outer peripheral layer having an inner peripheral layer made into close contact with an outer peripheral surface of the inner peripheral layer, wherein a compressed gas is fed into a compressed gas supply passage formed in an axially end part of the outer peripheral layer so as to jet the compressed gas from jet ports formed in the end part and opened from the inner peripheral surface of the outer peripheral layer toward the inner peripheral layer, in order to decrease a diameter of the inner peripheral layer by means of a gas layer formed at the boundary between the inner peripheral layer and the outer peripheral layer, and the inner peripheral layer is fitted in or is pulled out from the inner peripheral surface of the outer peripheral layer, and in the case of fitting the inner peripheral layer into the outer peripheral layer, the supply of the compressed gas is stopped so as to enlarge the diameter of the new inner peripheral layer in order to closely fit the inner peripheral layer in the inner peripheral surface of the outer peripheral layer after the inner peripheral layer is fitted in the inner peripheral surface of the outer peripheral layer.

Thus, the removal and fitting of the inner peripheral layer from and into the outer peripheral layer can be readily carried out without the necessity of a large scale facility.

### BRIEF DESCRIPTION OF THE DRAWINGS

FIG. 1 is a schematic view illustrating an entire configuration of an offset web press;

FIG. 2 is a schematic view illustrating a configuration of a printing unit in the web press show in FIG. 1;

FIG. 3 is a partly broken perspective view illustrating a plate cylinder in a first embodiment of the present invention;

FIG. 4 is a longitudinal sectional view illustrating a sleeve for a plate cylinder in the first embodiment of the present invention;

FIG. 5 is a cross-sectional view along line A-A in FIG. 4;

FIG. 6 is a side view illustrating the first embodiment;

FIG. 7 is a sectional view along C-C in FIG. 6;

FIG. 8 is an enlarge view of a part B in FIG. 4;

FIG. 9a is a partly cross-sectioned side view illustrating a part around a positioning fixture in the first embodiment,

FIG. 9b is a sectional view along line D-D in FIG. 9c;

FIG. 9c is a bottom view illustrating the part around the positioning fixture as viewed from the inner peripheral side;

FIG. 10 is a longitudinally sectional view illustrating an inner peripheral layer in the first embodiment;

FIG. 11 is a longitudinal sectional view illustrating a sleeve for a plate cylinder in a second embodiment of the present invention;

FIG. 12 is a cross-sectional view along line E-E in FIG. 11;

FIG. 13a is a cross-sectional view illustrating a third embodiment of the present invention;

FIG. 13b is an enlarged view of a part F in FIG. 13a.

### DETAILED DESCRIPTION OF THE PREFERRED EMBODIMENTS

Explanation will be hereinbelow made of embodiments of the present inventions with reference to the accompanying drawings. It is noted that dimensions, materials, shapes, relative positions of component parts explained in the preferred embodiments should not be intended to limit the technical scope of the present invention only thereto unless otherwise specified.

### Embodiment 1

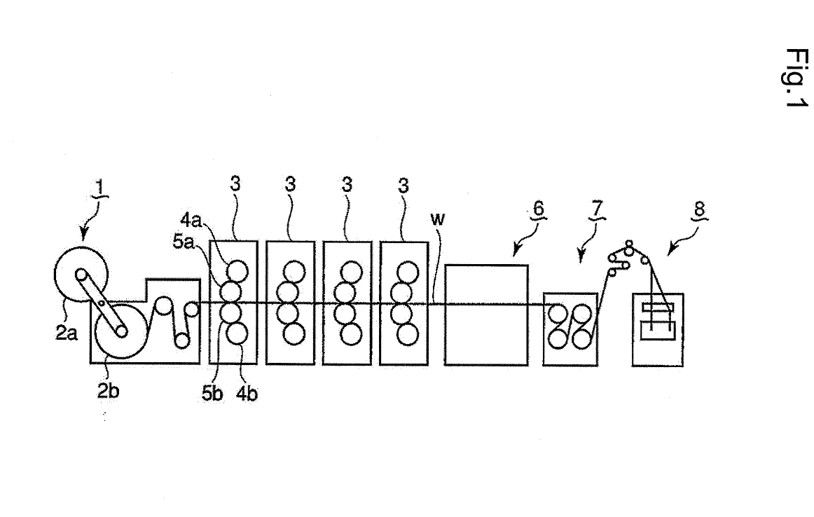

An offset web press shown in FIG. 1 is of a variable cutoff type capable of changing a cutoff length (cutting length) of a web, and is composed of a paper feeder 1 for feeding a web w, a plurality of printing units 3, a dryer 6 for drying a printed web w, a cooler 7 for cooling the web w, a folding machine 8 for cutting and folding the web w so as to discharge cut web pieces in the form of a signature.

The paper feeder 1 is provided therein with two paper rolls 2a, 2b on which webs w are wound in the form of rolls, and the first roll 1a is mounted so as to prepare splicing of the web w while a web w is fed from the second roll 2b. When the remaining quantity of the web w in the second roll 2b becomes less, the web w from the second roll 2b is spliced to the web w from the first roll 2a. Thus, the web w can be continuously paid out from the paper feeder 1 to the printing units 3.

The number of the printing units corresponds to a number of colors to be printed. In this embodiment, the printing units 3 are provided by four so as to print cyan, yellow, magenta and blacks, respectively, and accordingly, with the use of the color mixture thereof, color printing is carried out. In the printing unit 3, there are arranged plates cylinders 4a, 4b and blanket cylinders 5a, 5b above and below the web w on running. The upper blanket cylinder 5a and the lower blanket cylinder 5b are opposed to each other with the web w being interposed therebetween, and both are arranged so as to apply a printing pressure to the web in cooperation thereof.

The plate cylinders 4a, 4b are wound thereon with press plates on which patterns are formed. These press plates are fed thereto with inks from inkers, and accordingly, the inks depict the patterns on the press plates, which are then transferred onto the blanket cylinders. Then the patterns are printed to the web w at both surfaces of the latter. The web w printed on its both surfaces is dried by the dryer 6, then is cooled by the cooler 7 and thereafter, it is fed to the folding machine 8 in which the fed web w is longitudinally cut and folded by a triangular plate, and is then transversely cut and folded into a desired signature that is then discharged.

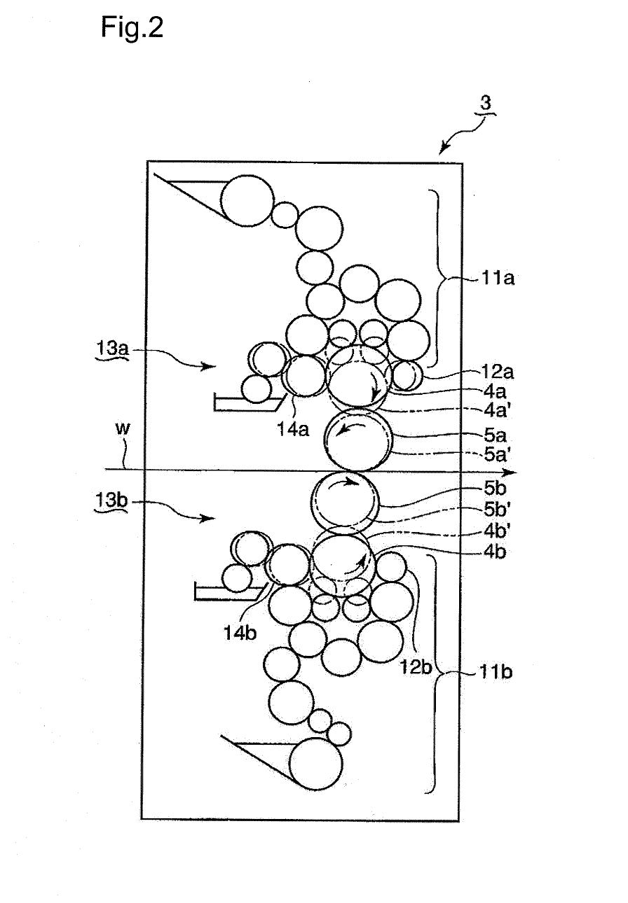

FIG. 2 schematically shows an entire configuration of the printing unit 3 in the web press shown in FIG. 1. The printing unit 3 comprises above-mentioned plate cylinders 4a, 4b and the blanket cylinders 5a, 5b which are arranged with the web w being interposed therebetween, ink supply devices 11a, 11b for feeding inks onto patterned parts on the press plates which are wound on the plate cylinders 4a, 4b but which are not shown, paper wetting units 13a, 13b for feeding wetting water to nonpatterned parts of the plate cylinders 4a, 4b.

In the web press in this embodiment, the plate cylinders 4a, 4b and the blanket cylinders 5a, 5b can be replaced with plate cylinders 4a′, 4b′ and blanket cylinders 5a′, 5b′ which have different diameters in order to change a cutoff length (cutting length) of the web w. That is, each of the plate cylinders 4a, 4b and the blanket cylinders 5a, 5b is composed of a base shaft roll and a cylindrical sleeve with which the outer surface of the former is covered, and the diameter of the cylinder is changed by changing sleeves having different outer diameters.

Further, when the diameters of the plate cylinders 4a, 4b and the blanket cylinders 5a, 5b are changed, the positions of the center axes of the plate cylinders 4a, 4b and the blanket cylinders 5a, 5b are vertically displaced as indicated by reference numerals 4a′, 4b′, 5a′, 5b′.

Further, the positions of the center axes of ink applying rollers 12a, 12b of the ink applying devices 11a, 11b and water applying rolls 14a, 14b of the wetting devices 13a, 13b are also changed as indicated by the two-dot chain lines.

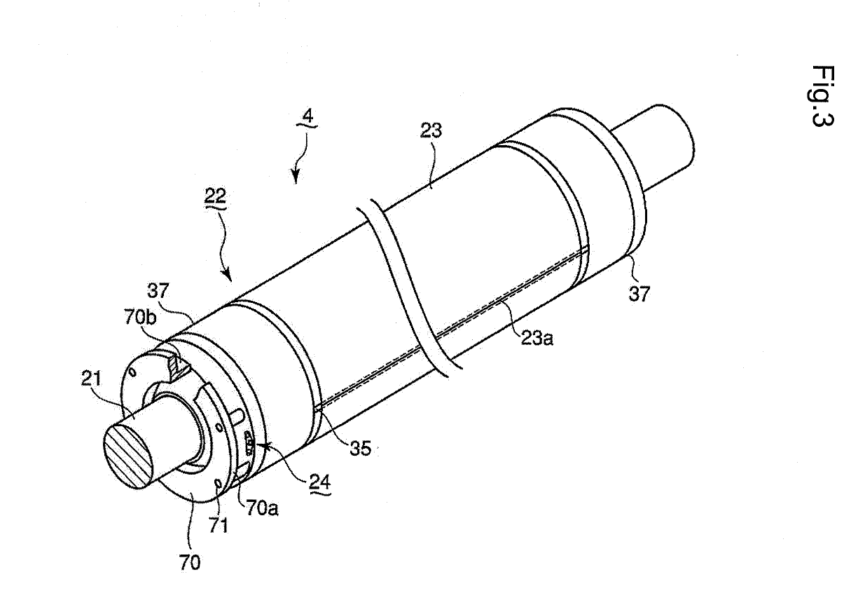

The printing cylinder 4 (subscripts a and b are abbreviated when 4a and 4b are not explained being different from each other) is composed of, as shown in FIG. 3, a cylindrical sleeve 22 for a plate cylinder, which is fitted on the outer periphery of the base shaft roll 21, and a press plate 23 formed therein a pattern and wound on the outer periphery of the sleeve 22. The press plate 23 is gripped and fixed at its both circumferential end 23a by the plate holder 24. The plate holder 24 is provided in the sleeve 22 for a plate cylinder as will be described later.

It is noted that the blanket cylinder 5 is composed of a sleeve for a blanket cylinder fitted on the outer periphery of a base shaft roll, similar to the plate cylinder.

Explanation will be hereinbelow made of the sleeve for a plate cylinder in this embodiment with reference to FIGS. 3 to 10. As shown in FIGS. 3 and 4, the sleeve 22 for a plate cylinder is cylindrical, and is composed of an outer peripheral layer 31 made of aluminum alloy and an inner peripheral layer 32 made of resin. The inner peripheral layer 32 is composed of an elastic layer 33 made of, for example, foamed rubber or solid rubber so as to be elastic, and an inner FRP layer 34, as shown in FIG. 8. The outer peripheral layer 31 and the inner peripheral layer 32 are formed separate from each other, that is, they are separatable from each other.

The outer peripheral layer 31 shown in FIG. 4, is made of aluminum alloy in order to be lightweight and as well to have a required strength. The aluminum alloy layer is applied over its outer surface with a hardening process such as anodizing, thereby it is possible to restrain the outer surface from being worn or damaged. Since the outer peripheral layer 31 is made of aluminum alloy having a strength higher than that of the resin, it is possible to enhance the strength and the durability of the sleeve in comparison with a sleeve 22 for a plate cylinder which is made of resin in its entirety. Accordingly, the plate holder 24 can be attached to the sleeve 22 for a plate cylinder.

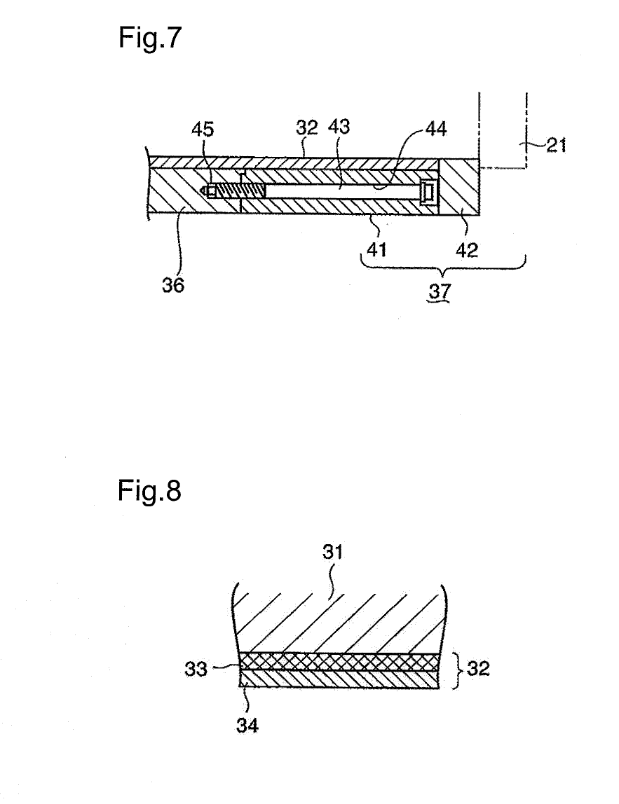

The outer peripheral layer 31 is composed of a center part 36 located at the axial center, and end parts 34 located at opposite ends of the center part 36. The center part 36 and connection parts 41 which constitute parts of the end parts 37 are removably attached to each other by means of bolts 43, as shown in FIG. 7.

The center part 36 of the outer peripheral layer 31 occupies the most part of the outer peripheral layer 31 made of aluminum alloy, having an axial length which is slightly longer than that of the press plate 32 (refer to FIGS. 3 and 4) wound on the sleeve. The sleeve 22 of a plate cylinder is formed therein a hole 38 axially piercing therethrough, and a tension bar 39 of the plate holder 24 is inserted in the hole 38. The center part 38 is formed therein a groove 35 which connects the hole 38 with the outer peripheral surface of the sleeve 22 for a plate cylinder.

The method of mounting the plate 23 on the sleeve 22 for a plate cylinder includes the following steps: The plate cylinder 4 is rotated by one turn in such a condition that the leading bite end part of the press plate 23 is locked to a corner of the groove 35, and accordingly, the press plate 23 is wound around the outer peripheral surface of the sleeve 22. Then, the trailing bite end part of the press plate 23 is inserted in the hole 38 by way of the groove 35, and is engaged with a hook part, which is not shown, of the tension bar 39, and in this condition, a handle 40 of the plate holder 24 is turned. Thus, the tension bar 39 is rotated so as to pull the trailing bite end of the plate 23 so as to fasten the press plate 23 under tension, and simultaneously, the leading bite end of the plate 23 is clamped between the inner surface of the hole 38 and the tension bar 39 so as to be fixed. It is noted that, for example, Japanese Patent Laid-Open No. 2000-6372 discloses the plate holder in detail.

Each of both end parts 37 of the outer peripheral layer 31 is composed of the connection part 41 and an edge part 42 as shown in FIG. 4. Further, this connection part 41 has inner and outer diameters which are equal to those of the center part 36, and the edge part 42 is located nearer to one end than the connection part 41. The edge part 41 has an outer diameter equal to that of the connection part, but has an inner diameter smaller than that of the connection part 41. That is, the edge part 42 has a wall thickness which is larger than that of the connection part 41.

Further, the edge part 42 has an inner diameter which is slightly larger than that of the inner peripheral layer 32. Further, when the inner peripheral layer 32 of the sleeve 22 for a plate cylinder is fitted on the base shaft roll 21 while its diameter is enlarged in a fitting method which will be detailed later, the inner diameter of the edge part is set such as to be slightly larger than that of the inner peripheral layer 32 whose diameter is enlarged, but slightly smaller than the outer diameter of the inner peripheral layer.

The edge part having the inner diameter which is set as stated above, is arranged at each of both ends of the sleeve 22 for a plate cylinder so as to hold the inner peripheral layer 32 between both edge parts 42.

The connection part 41 is formed therein with through-holes 44 into which bolts 43 are inserted for connection with the center part 36, at six positions with equal angular pitches in the circumferential direction as shown in FIG. 6. That is, the bolts 43 are inserted into the through-holes 44, and are then screwed into thread holes 45 formed in the center part 36, and accordingly, the connection parts 41 are fixed to the center part 36.

As shown in FIG. 4, each connection part 41 is formed therein with thread-holes 49 while the edge part 42 is formed therein with through-holes 50, and accordingly, bolts 46 are inserted in the through-holes 50 and are screwed into the thread holes 49 so as to fix the edge part 42 to the connection part 41. As shown in FIG. 6, each edge part 42 is fixed to the connection part 41 by the bolts 46 which are screwed into the above-mentioned thread holes 49 at six positions formed in the circumferential direction.

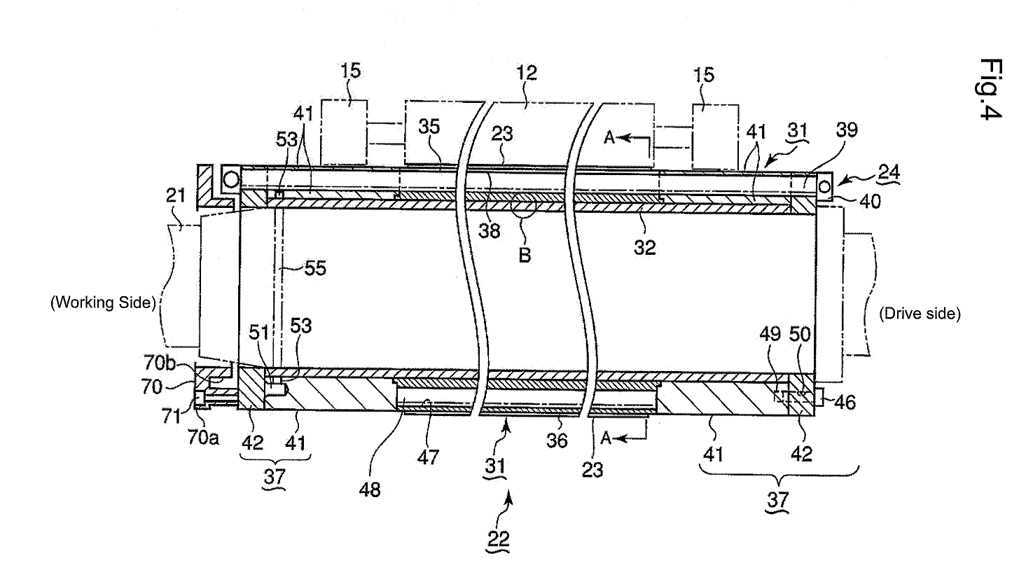

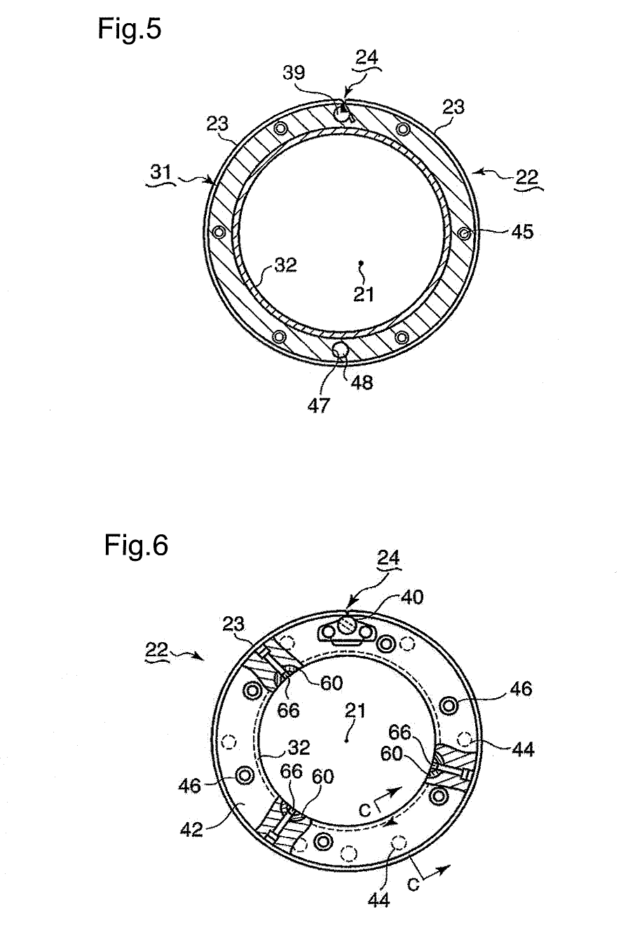

It is noted that the plate holder 24 is made of steel, and accordingly, the weight of one side of the sleeve 22 for a plate cylinder becomes heavier, and accordingly, the sleeve 22 cannot be balanced during printing operation as it is. Thus, as shown in FIG. 5, an axial hole 47 is formed in the sleeve at a position which is point-symmetric with the plate holder 24 with respect to the center axis of the sleeve 22 for a plate cylinder, as shown in FIG. 5, and a rod-like steel balance weight 48 is inserted and fixed in the hole 47 in order to balance the sleeve 22 for a plate cylinder.

Further, as shown in FIG. 4, the outer peripheral surfaces of the connection parts serve as rolling portions for rolling the nip adjusting rolls 15 for adjusting a nip pressure of the ink applying roll 12. Since these connection parts 41 are made of light alloy such as aluminum alloy or the like, the abrasion of the connection parts 41 can be remarkably reduced in comparison with such a case that they rolls on a resin material of which a sleeve is made.

Further, even though the connection parts 41 are worn through rolling of the nip adjusting rolls 15, since the connection parts 41 are removable from the center part 36, only the connection parts 41 can be replaced with new ones. Thus, it is not necessary to replace the outer peripheral layer 31 in its entirety or the sleeve for a plate cylinder itself with new one. Thereby it is possible to reduce the costs required for replacement of the sleeve 22 for a plate cylinder.

As shown in FIG. 6, positioning fixtures 60 are provided in the inner periphery of each of the edge part 42. The positioning fixtures 60 are adapted for positioning the sleeve 22 for a plate cylinder with respect to the base shaft roll 21 when the sleeve 22 for a plate cylinder is fitted on the base shaft roll 21 in both in circumferential and axial directions. In this embodiment, the positioning fixtures 60 are provided by three at equal pitches in the circumferential direction. However, the present invention should not be limited to three positioning fixtures, that is, not less than 1 of them may be sufficient.

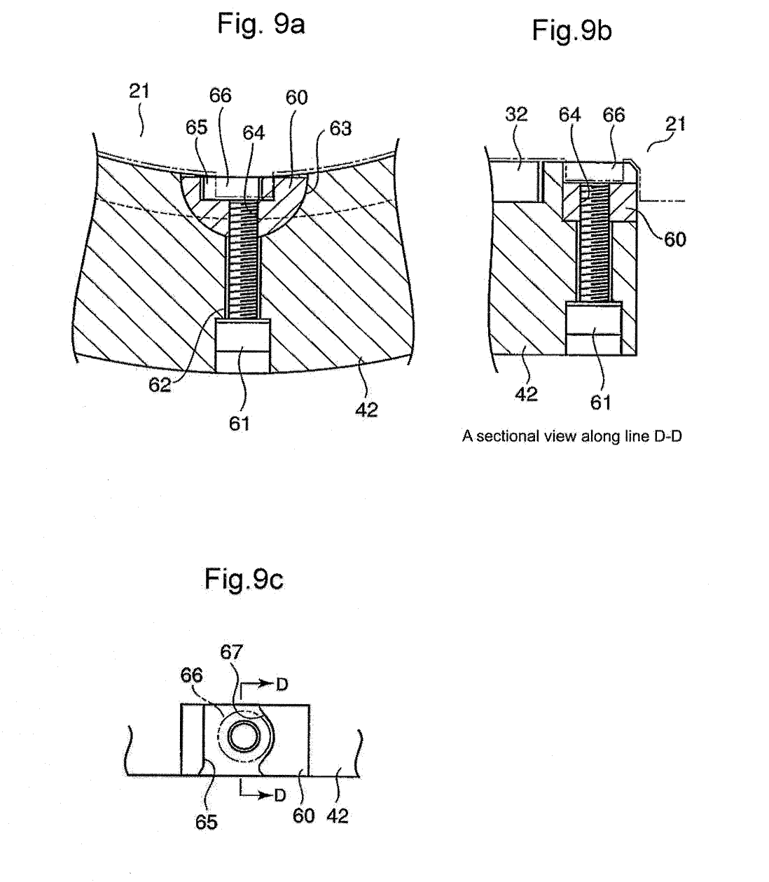

The positioning fixtures 60 are fixed by bolts 61 which are inserted in the edge parts 42 from the outer periphery to the center thereof, as shown in FIGS. 9a and 9b. The edge parts 42 are formed therein with radial screw holes 62, and are also formed in its inner peripheral surface with recess 63 for accommodating the positioning fixtures 63.

Further, the positioning fixture 60 is formed therein with a screw hole 64 adapted to be threadedly engaged with the bolt 61. Further, by screwing the distal end part of the bolt 61 into the screw hole 64 in the positioning fixture 60 accommodated in the recess 63, the positioning fixture 60 is fixed in the recess 63.

The positioning fixture 60 is formed in a semi cylindrical column-like shape having a substantially semicircular cross-sectional shape.

As shown in FIG. 9c, a groove 65 is formed in a planar bottom surface of the positioning fixture 60, being extended in the axial direction of the sleeve 22, and the groove 65 is formed therein with an arcuated recess 67 in which the side peripheral surface of a pin (protrusion) 67 that is projected from the outer periphery of the base shaft roll 21 is engaged. The pin 66 of the base shaft roll 21 is engaged in the recess 67 so that the circumferential and axial positions of the sleeve 22 are determined.

Since the edge parts 42 of the outer peripheral layer 31 which are attached thereto with the positioning fixtures 60 as stated above, are made of aluminum alloy so as to have a necessary strength, the positioning fixtures 60 can be fixed by the bolts 61. Accordingly, it is not necessary to fix it with the use of an adhesive as used for a conventional resin sleeve. Thus, since the positioning fixture 60 is fixed only by the bolts 61, even though the positioning fixture 60 is worn or damaged, only the positioning fixture 60 may be replaced with new one, thereby it is possible to extremely simplify the replacement.

As shown in FIG. 4, a gripping ring 70 is removably attached to the edge part 42 of the end part 37 on the manipulation side (the left side of the sheet surface of FIG. 4) of the sleeve 22 for a plate cylinder by bolts 71. The gripping ring 70 is adapted to be gripped by a worker for fitting or removing the sleeve 22 for a plate cylinder onto or from the base shaft roll 21 when the sleeve 22 for a printing roll is fitted onto or removed from the base shaft roll 21.

The gripping ring 70 has a large diameter part 70 having a diameter substantially equal to that of the sleeve 22 for a plate cylinder, and a small diameter part 70b located within the inside of the large diameter part 70a.

The worker grips the large diameter part 70a so as to carry out fitting and removable of the sleeve 22 for a plate cylinder. Since a gap is defined between the large diameter part 70a and the end surface of the sleeve 22 for a plate cylinder as shown in FIG. 3, the worker can insert his fingers in the gap in order to facilitate the gripping of the gripping ring 70.

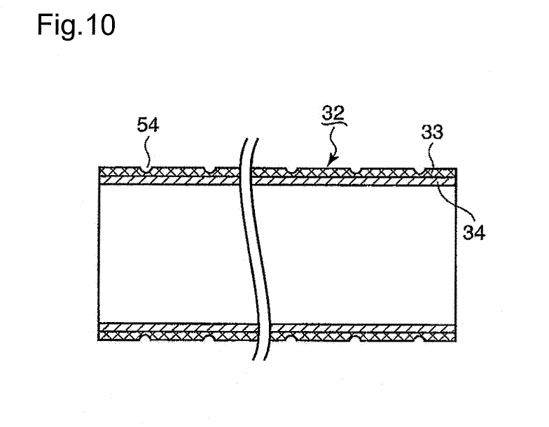

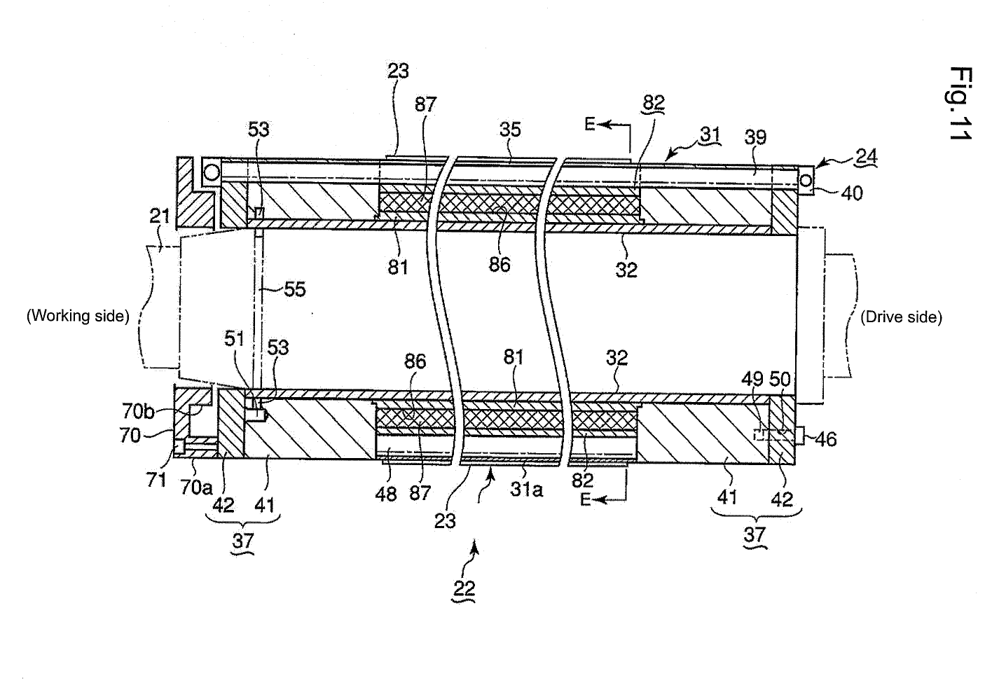

Further, the connection part 41 on one end side of the sleeve outer peripheral layer 31 is formed therein with a hole for feeding compressed air and jet ports 53 communicated with the hole 51. The jet ports 53 are formed in the inner peripheral surface of the outer peripheral layer 31 abutting the inner peripheral layer 32, and further, are annularly opened surrounding the inner peripheral layer 32. Further, the outer peripheral layer 32 is formed in its outer peripheral surface with a plurality of ring-like groove 51 at suitable pitches as shown in FIG. 10.

In the first embodiment configured as stated above, explanation will be made of process steps for fitting the sleeve 22 for a plate cylinder onto the base shaft roll 21. Since the outer peripheral layer 31 and the inner peripheral layer 32 which constitute the sleeve 22 for a plate cylinder are formed, being separated from each other, it is required at first to fit the inner peripheral layer 32 into the outer peripheral layer 31. It is noted that the inner peripheral layer 32 is formed so as to have an outer diameter of the outer peripheral surface thereof, which is slightly larger than the inner diameter of the inner peripheral surface of the outer peripheral layer 31.

In a condition in which the center part 36 is coupled thereto with the connection parts 41 while the edge parts 42 are removed, a compressed air is fed into the hole 51 for feeding the compressed air, formed in the connection part 42, from a compressed air source which is not shown, and the inner peripheral layer 32 is gradually fitted in the inner peripheral surface of the outer peripheral layer 31 while the compressed air is jetted from the jet ports 53.

At this time, the diameter of the outer peripheral surface of the end side of the inner peripheral layer 32, on to which the compressed air is jetted, is reduced by the compressed air, and when the inner peripheral layer 32 is inserted into the outer peripheral layer 31, the diameter of the inner peripheral layer 32 is reduced on the side which is inserted into the outer peripheral layer 31 by the air filled between the outer peripheral surface of the inner peripheral layer 32 and the inner peripheral surface of the outer peripheral layer 31. Thus, a gap is formed between the inner peripheral surface of the outer peripheral layer 31 and the outer peripheral surface of the inner peripheral layer 32, and accordingly, a frictional resistance caused by the contact between the inner peripheral surface of the outer peripheral layer 31 and the outer peripheral surface of the inner peripheral layer 32 is decreased.

Further, the inner peripheral layer 32 can be smoothly inserted into the inner peripheral surface of the outer peripheral layer 31. In particular, since the compressed air is introduced in the ring-like groove 54 formed in the outer peripheral surface of the inner peripheral layer 32, an air film is surely formed between the outer peripheral surface of the inner peripheral layer 32 and the inner peripheral surface of the outer peripheral layer 31 so as to decrease the contact area between the inner peripheral layer 32 and the outer peripheral layer 31. It is noted that the intervals of the ring-like groves are suitably set so as to facilitate the formation of the air film between the outer peripheral surface of the inner peripheral layer 32 and the inner peripheral surface of the outer peripheral layer 31.

With the above-mentioned process steps, the inner peripheral layer 32 is fitted in the inner peripheral surface of the outer peripheral layer 31 in its entirety. Thereafter, the supply of the compressed air into the hole 51 is stopped, and the bolts 46 are screwed into the screw holes 49 in the connection parts 41 so as to couple the edge parts 42 to the connection parts 41, resulting in such a condition that the inner peripheral layer 32 is held between the edge parts 42 at the opposite ends (the condition shown in FIG. 4).

Next, the sleeve 22 for a plate cylinder in which the outer peripheral layer 31 is united with the inner peripheral layer 32 is fitted onto the base shaft roll 21. In this case, the gripping ring 70 is attached to the sleeve 22 for a plate cylinder by means of the bolts 71, and the worker grips the gripping ring 70. Thus, the sleeve 22 for a plate cylinder is fitted onto the base shaft roll 21 from its drive side end part 37 (on the right side in FIG. 4). A compressed air is fed into compressed air jet ports 55 which are formed in the outer peripheral surface of the manipulation side end part of the base shaft roll 21 in the circumferential direction, from the compressed air source which is not shown. The inner peripheral layer 32 of the sleeve 22 for a plate cylinder is expanded by the pressure of the compressed air jetted from the jet ports 55 so as to enlarge the diameter thereof while it is fitted on the base shaft roll 21.

It is noted that the edge part 42 of the outer peripheral layer 31 is formed so as to have an inner diameter which is slightly larger than the outer diameter of the base shaft roll 21, and accordingly, upon fitting of the sleeve, no interference occurs with respect to the outer peripheral surface of the base shaft roll 21.

Further, when the sleeve 22 for a plate cylinder is further pushed toward the drive side while the circumferential position of the sleeve 22 for a plate cylinder is adjusted with respect to the base shaft roll 21, the pins 66 (refer to FIGS. 6 and 9) formed being projected from the outer peripheral surface of the base shaft roll 21 are fitted in the groove 65 in the positioning fixtures 60. Further, the pins 66 are engaged in the recesses 67 in the groove 65 of the positioning fixtures 60, and accordingly, the sleeve 22 for a plate cylinder is positioned in both circumferential and axial directions.

Thereafter, the press plate 23 is wound around the outer periphery of the sleeve 22 for a plate cylinder, and the press plate 23 is fixed by the plate holder 24, and thereafter, printing operation is started.

It is noted that the gripping ring 70 may be attached when the sleeve 22 for a plate cylinder 22 is pulled out from the base shaft roll 21.

After the printing operation has been carried out for a predetermined period with the sleeve 22 for a plate cylinder being fitted on the base shaft roll 21, if the performance of the inner peripheral layer 32 has been deteriorated, resulting in requirement for replacement of the sleeve 22 for a plate cylinder, it is necessary to remove the sleeve 22 for a plate cylinder from the base shaft roll 22. In this case, a compressed air is jetted from the compressed air jet ports 55 formed in the outer peripheral surface of the base shaft roll 21 so as to enlarge the inner peripheral layer 32 of the sleeve 22 for a plate cylinder in order to float up the inner peripheral layer 32 from the outer peripheral surface of the base shaft roll 21. In this condition, the worker grips the gripping ring 70 and pulls out the sleeve 22 for a plate cylinder. Thus, the removable of the sleeve 22 for a plate cylinder is completed.

In the case of removal of the inner peripheral layer 32 from the outer peripheral layer 31 of the sleeve 22 for a plate cylinder, the edge parts 42 are at first removed from the connection parts 41, and thereafter, compressed air is jetted from the jet ports 53 by way of the compressed air feed port 51 so as to decrease the diameter of the inner peripheral layer 32 by the pressure of the compressed air in order to define a gap between the outer peripheral surface of the inner peripheral layer 32 and the inner peripheral surface of the outer peripheral layer 31 by means of the air trapped therebetween. Thus, the frictional resistance caused by the contact therebetween is reduced in order to pull out the inner peripheral layer 32 from the outer peripheral layer 31. Further, a new inner peripheral layer 32 is fitted in the outer peripheral layer 31, and thereafter, the sleeve 22 for a plate cylinder 22 is fitted on the base shaft roll 21.

In the first embodiment as stated above, the outer peripheral layer 31 constituting the sleeve 22 for a plate cylinder together with the inner peripheral layer 32 is made of aluminum alloy so as to be lightweight and to have a high strength, and the inner peripheral layer 32 is composed of the elastic layer 33 formed of solid rubber or foamed rubber and the FRP layer 34 arranged inside of the elastic layer 33 so that that the sleeve 22 for a plate cylinder can be simply removed or fitted from and onto the base shaft roll 21 by enlarging the sleeve 22 for a plate cylinder by the compressed air. Further, since the sleeve 22 for a plate cylinder has a high strength and is composed of the outer peripheral layer 31 and the inner peripheral layer 32 which are separatable from each other, when the inner peripheral layer 32 having a relatively short service life is deteriorated so as to lower its performance, only the inner peripheral layer may be replaced with new one without replacing the sleeve for a plate cylinder in its entirety, thereby it is possible to greatly reduce the replacement costs of the sleeve.

Further, the removal and the fitting of the inner peripheral layer 32 from and into the outer peripheral layer 31 can be simply carried out by jetting the compressed air fed through the compressed air supply port 51, from the jet ports 53 so as to direct the compressed air from the inner peripheral surface of the outer peripheral layer 31 toward the outer peripheral surface of the inner peripheral layer 32 in order to reduce the outer diameter of the inner peripheral layer by the pressure of the compressed air, and by introducing the compressed air between the inner peripheral surface of the outer peripheral layer 31 and the outer peripheral surface of the inner peripheral layer 32 so as to form a gap between the outer peripheral layer 31 and the inner peripheral layer 32.

In this embodiment, since the ring-like groove 54 are formed in the outer peripheral surface of the inner peripheral layer 32, the effect by the air sump between the inner peripheral surface of the outer peripheral layer 31 and the outer peripheral surface of the inner peripheral layer 32 is higher, thereby it is possible to ensure the gap between the inner peripheral layer and the outer peripheral layer.

### Embodiment 2

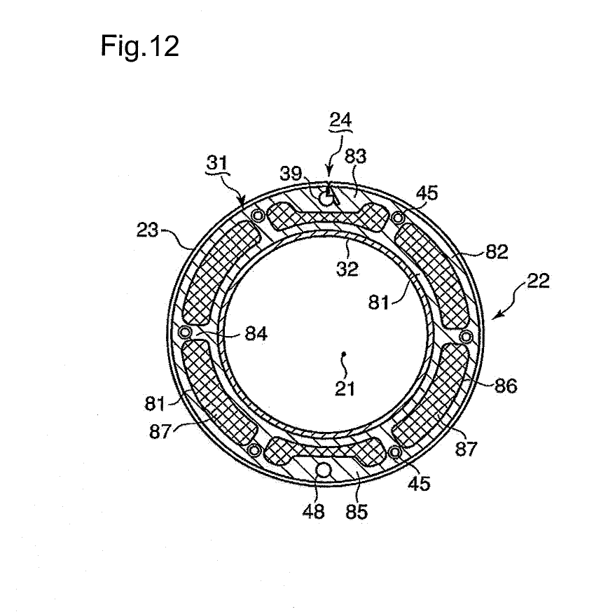

Next, explanation will be made of a second embodiment of the present invention with reference to FIGS. 11 and 12. This embodiment is the same as that of the first embodiment, except that the outer layer 31 made of aluminum alloy is formed with a hollow space in the part which does not require a relatively high strength, and a foamed urethane layer is filled in the hollow space. That is, as shown in FIG. 12, in the center part 36 of the outer peripheral layer, an inner cylinder (first cylinder) 81 arranged in the vicinity of the inner peripheral surface of the sleeve, and facing the inner peripheral surface, and an outer cylinder (second cylinder) 82 arranged in the vicinity of the outer peripheral surface of the sleeve 22 for a plate cylinder and facing the outer peripheral surface, are made of aluminum while parts 83 around the plate holder 24, a coupling part 84 for coupling the cylinder 81 and the cylinder 82 at a position of the screw holes 45 for coupling the connection parts 41 to the center part 36 by bolts and a part 85 around the balance weight 48 are made of aluminum alloy, and the center part is formed therein with a hollow space except the above-mentioned parts, and the thus formed hollow space is filled therein with the foamed urethane layer 87.

It is noted that the configuration except those as stated above is the same as that of the first embodiment, including the end parts of the outer peripheral layer 31 and the inner peripheral layer 32. Thus, like reference numbers are used to denote like parts to those explained in the first embodiment in order to omit the explanation thereto. Further, in FIG. 11, the ink applying roll 12, the nip adjusting rolls 15 and the gripping ring 60 are not shown.

In this embodiment, since the outer peripheral layer 31 and the inner peripheral layer 32 are separatable from each other, when the inner peripheral layer 32 having a relatively short service life is deteriorated so as to lower its performance, only the inner peripheral layer 32 can be replaced with new one without replacing the sleeve 22 for a plate cylinder in its entirety, thereby it is possible to greatly reduce the replacement costs.

Further, since the center part 36 of the outer peripheral layer 31 is formed therein with the hollow space in the part in which the strength can be reduced, and since the lightweight foamed urethane layer 87 is filled in the hollow space 86, it is possible to allow the sleeve 22 for a plate cylinder to be lightweight while a strength necessary for the sleeve for a plate cylinder is maintained. Since the foamed urethane has a small density of about 0.5, and has a specific weight which is about ⅕ of that of aluminum while it has a relatively large strength, it is possible to aim at making the sleeve 22 for a plate cylinder greatly lightweight without substantially reducing the strength thereof in comparison with a sleeve for a plate cylinder having an outer peripheral layer made of aluminum in its entirety.

### Embodiment 3

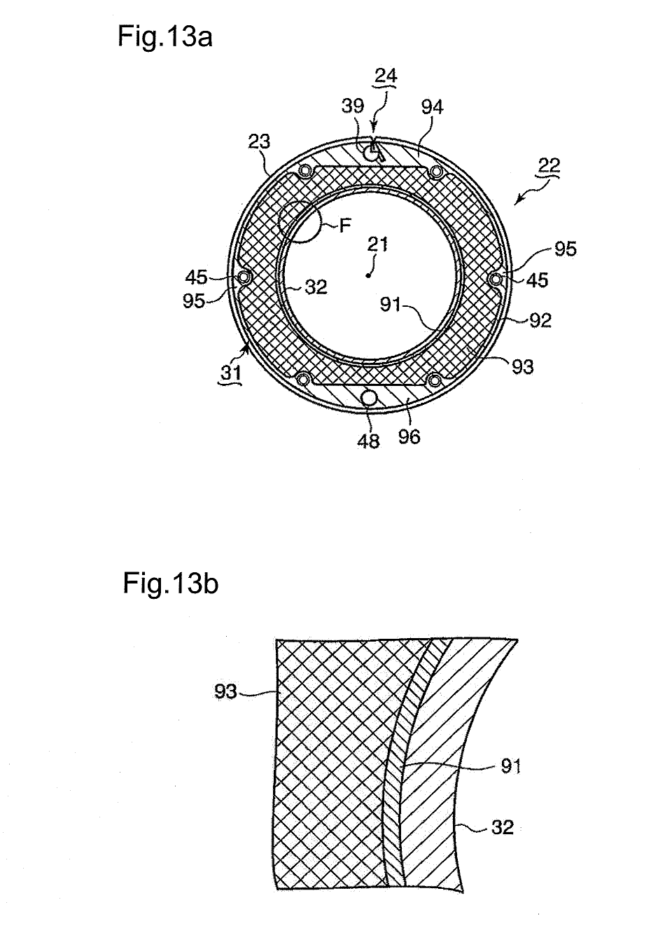

Next, explanation will be made of a third embodiment of the present invention with reference to FIG. 13a and FIG. 13b. In this embodiment, a cylinder (first cylinder) 91 having a thin wall thickness and made of Ni and a cylinder (second cylinder) 92 made of aluminum alloy are concentrically aligned with each other, and liquid urethane is filled between these cylinders, is then foamed and solidified so as to form a foamed urethane layer 93. Thus, the outer peripheral layer 31 is composed of the cylinders 91, 92 and the foamed urethane layer 93.

It is noted that in the cylinder 92, a part 94 around the plate holder 24, a part 95 around the through holes 44 for the connection bolts for connecting the edge parts to the connection parts 41 and a part 96 around the balance weight 48, which require in particular a high strength, are made of aluminum alloy. The configuration of this embodiment is the same as that of the first embodiment, except the above-mentioned configuration, and accordingly, the like reference numerals are used to denote like parts in the first embodiment in order to abbreviate the explanation thereto.

In the third embodiment as stated above, in addition to such an advantage that the outer peripheral layer 31 and the inner peripheral layer 32 are separatable from each other, similar to the embodiments 1 and 2, so as to greatly reduce the replacement costs, since the thin wall cylinder 91 is made of Ni which has a high strength, a long service life and a high working ability, and accordingly, the thin wall (for example, 0.1 mm) can be manufactured with a high degree of accuracy, and as well, with the use of the convenient method in which the liquid urethane is merely filled between the cylinder 91 and the cylinder 92 which are made of aluminum and which are concentrically aligned with each other, there can be simply manufactured the sleeve for a plate cylinder, which is lightweight and which has a high strength.

It is noted that although the explanation has been made of the preferred embodiments in which the present invention is applied for a sleeve for a plate cylinder, the present invention can be applied for a sleeve for a blanket cylinder.

According to the present invention, in an offset web press, there can be provided a sleeve for a printing press and a method of fitting the sleeve, with which the costs of replacement of the sleeve for a printing cylinder, that is fitted on a base shaft roll can be reduced to an inexpensive price, and in particular, the present invention is in particular preferably applied for a variable cutoff type web press which requires preparation of several sleeves for a printing cylinder, having different diameters.

1. A cylindrical sleeve for a printing cylinder fitted on an outer periphery of a base shaft roll provided on a body side of a printing machine, comprising:
an inner peripheral layer composed of a plurality of layers at least one of which is expandable and contractible with respect to a radial load, and an outer peripheral layer closely fitted on an outer peripheral surface of the inner peripheral layer,
characterized in that the inner peripheral layer and the outer peripheral layer are formed separate from each other so as to be separate able from each other.

2. A sleeve for a printing cylinder as set forth in claim 1, characterized in that the outer peripheral layer is incorporated in an axially end part thereof with
a supply passage for feeding a compressed gas for removing or fitting the inner peripheral layer, and
jet ports connected with the supply passage, for jetting the compressed gas from an inner surface of the end part of the outer peripheral layer toward the inner peripheral layer.

3. A sleeve for a printing cylinder as set forth in claim 1, characterized in that the inner peripheral layer is provided in its outer peripheral surface with circumferential groove.

4. A printing sleeve as set forth in any one of claim 1, characterized in that the outer peripheral layer is formed with a hollow space in the part capable of lowering its strength, and a lightweight nonmetallic material is filled in the hollow space.

5. A sleeve for a printing cylinder as set forth in any one claim 1, characterized in that the outer layer includes a first cylinder having an inner peripheral surface whose diameter is substantially equal to that of an outer peripheral surface of the inner peripheral surface,
a second cylinder made of a metal material and arranged outside of the first cylinder, being concentrically aligned with the first cylinder, and
the lightweight nonmetallic material is filled between the first cylinder and the second cylinder.

6. A sleeve for a printing cylinder as set forth in claim 4, characterized in that the lightweight nonmetallic material is foamed urethane.

7. A printing machine incorporating a sleeve for a printing cylinder fitted on a base shaft roll which is provided on a body side of the printing machine, the sleeve for a printing cylinder comprising an inner peripheral layer composed of a plurality of layers at least one of which is expandable and contractible with respect to a radial load, and an outer peripheral layer closely fitted on an outer peripheral surface of the inner peripheral layer, characterized in that the inner peripheral layer and the outer peripheral layer are formed separate from each other so as to be separateable from each other.

8. A printing machine as set forth in claim 7, characterized in that the sleeve for a printing cylinder used as a sleeve for a plate cylinder or a sleeve for a blanket cylinder, and the printing machine is a variable cutoff type web press capable of changing a cutoff length of a web.

9. A method of fitting and removing an inner peripheral sleeve into and from an outer peripheral layer of a sleeve for a printing cylinder as set forth in claim 2,
characterized in that a compressed gas is fed into the supply passage and is then jetted from the jet ports so as to form a gas layer at a boundary between the outer peripheral layer and the inner peripheral layer in order to reduce a diameter of the inner peripheral layer while the inner peripheral layer is fitted in the inner peripheral surface of the outer peripheral layer or is pulled out from the inner peripheral surface of the outer peripheral layer.

10. A method for fitting and removing an inner sleeve into and from an outer peripheral cylinder as set forth in claim 9, characterized in that the supply of the compressed gas is stopped so as to allow the inner peripheral layer to restore its original diameter after the inner peripheral layer is fitted in the inner peripheral surface of the outer peripheral layer, in order to closely fit the inner peripheral layer in the inner peripheral surface of the outer peripheral layer.

11. A method of fitting and removing an inner peripheral layer from a sleeve for a printing cylinder as set forth in claim 8, characterized in that groove are formed in an outer peripheral surface of the inner peripheral layer in order to introduce the compressed gas into the groove.
